(19) United States
(12) Patent Application Publication
(10) Pub. No.: US 2020/0143706 A1
(43) Pub. Date: May 7, 2020

(54) EDUCATIONAL AID

(71) Applicant: James Higgins, Forest Lake, Brisbane, Queensland (AU)

(72) Inventor: James Higgins, Forest Lake, Brisbane, Queensland (AU)

(21) Appl. No.: 16/612,283

(22) PCT Filed: May 9, 2018
(86) PCT No.: PCT/AU2018/050428

§ 371 Date: Nov. 8, 2019

(30) Foreign Application Priority Data
May 10, 2017 (AU) 2017100520

(51) Int. Cl. G09B 23/18

(52) U.S. Cl. CPC G09B 23/185

(57) ABSTRACT

An educational aid and educational system is provided that enables a seamless transition between theoretical teachings and practical demonstration. The educational aid comprises: a circuit component, including first and second terminals and a portion of a circuit there between; and a schematic of the portion of the circuit extending between the first and second terminals. The educational aid is configured to be coupled to other educational aids using the terminals, to simultaneously create a circuit and a corresponding schematic.

### TECHNICAL FIELD

The present invention relates to education. In particular, although not exclusively, the present invention relates to an aid for education in the fields of electronic, electrical, technology and/or engineering study.

### BACKGROUND ART

Education in the fields of electronics generally has a theoretical component and a practical component. The theoretical component is often taught in a classroom environment (or as a lecture) using a white board and with the help of symbols and schematics. The practical component, on the other hand, is typically taught in a lab environment, where physical circuits are built and tested.

A problem with teaching electronics is that there is generally a disparity between the theoretical and practical components. In particular, students often have difficulty learning using symbols and schematics in the theoretical component, which may result in knowledge gaps required to successfully complete the practical components.

Certain attempts have been made to combine practical and theoretical teachings, by incorporating practical components into lectures. A problem with such teaching is that it is generally labour intensive, and typically only a limited number of students are able to get close enough to the circuit to be able to properly identify the electrical components.

Furthermore, even when practical and theoretical teachings are combined into a single class, this is generally done in a disruptive manner. In particular, the teacher may start by drawing a schematic on a whiteboard, and then switch to a demonstration of a circuit relating to that schematic.

This is clearly problematic as there is an abrupt transition between the theoretical and practical components, and students may still have difficulty linking the theoretical and practical components, and thus be left behind.

Similar problems exist in other areas of teaching, such as other types of electrical teaching, technology and/or engineering.

As such, there is a need for improved teaching methods and aids.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an educational aid, which may at least partially overcome at least one of the abovementioned disadvantages or provide the consumer with a useful or commercial choice.

With the foregoing in view, the present invention in one form, resides broadly in an educational aid comprising:

a circuit component, including first and second terminals and a portion of a circuit there between; and

a schematic of the portion of the circuit extending between the first and second terminals;

wherein the educational aid is configured to be coupled to other educational aids using the terminals, to simultaneously create a circuit and a corresponding schematic.

Preferably, the circuit is an electronic circuit. Alternatively or additionally, the circuit may comprise an electromechanical circuit, a pneumatic circuit, a hydraulic circuit, or any other suitable circuit, or combination thereof.

Preferably, the first and second terminals each comprise a connector or fastener. The connector or fastener may be specifically adapted to retain a conductive wire.

Preferably, the educational aid is substantially planar. Suitably, the educational aid comprises a plurality of planar layers. The planar layers may include a schematic layer, comprising the schematic, and a circuit layer, comprising the circuit.

The schematic layer may be superimposed on the circuit layer. The schematic layer may cover at least part of the circuit layer. The schematic layer may cover more than half of the circuit layer.

Preferably, the educational aid includes a magnet, configured to support the aid vertically. The magnet may comprise a magnetic layer. The magnetic layer may cover substantially an entire back of the circuit layer. A tab portion may be provided in the magnetic layer to simplify removal of the aid. Peg/grip/handle hidden

The schematic may be printed onto the schematic layer. The schematic layer may have an edge immediately adjacent to the first and second terminals of the circuit. The schematic may extend from the edge, to thus appear as a continuation from the first and second terminals.

The schematic may comprise wire elements, and one or more component elements. The wire elements may extend to the edge of the schematic layer.

The wire elements may be significantly larger than corresponding track elements of the circuit layer. Similarly, the one or more component elements may be significantly larger than corresponding components of the circuit layer. This may enable the wire elements and the component elements to be seen a distance from the aid, enabling a large number of students to read the corresponding schematic.

Preferably, the circuit layer includes a plurality of alternative configurations, of which one or more is chosen to define the circuit component. The alternative configurations may comprise predefined tracks, in relation to which components may be mounted.

The alternative configurations may be provided on edges of the circuit layer. The circuit layer may be rectangular in shape, and include at least one configuration for each edge of the rectangle.

The alternative configurations may be provided on the edges of the circuit layer, such that each edge does not include other alternative configurations. As such, a rectangular schematic layer may be provided that covers all other alternative configurations on that side of the circuit layer, but not the selected configuration.

The circuit layer may be double sided, and include alternative configurations on both sides of the circuit layer.

In another form, the invention resides broadly in an educational system comprising:

a plurality of educational aids, each educational aid comprising:
a circuit component, including first and second terminals and a portion of a circuit there between; and
a schematic of the portion of the circuit extending between the first and second terminals; and

a plurality of coupling elements, for coupling the plurality of educational aids with each other by respective first and second terminals;

wherein the educational aids are configured to be coupled with each other using the coupling elements, to simultaneously create a circuit and a corresponding schematic.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a front view of an electronics teaching aid, according to an embodiment of the present invention;

FIG. 2 illustrates an exploded side view of the electronics teaching aid of FIG. 1, according to an embodiment of the present invention;

FIG. 3 illustrates a rear view of the electronics teaching aid of FIG. 1, according to an embodiment of the present invention;

FIG. 4 illustrates a front view of an electronics teaching aid, according to an alternative embodiment of the present invention;

FIG. 5 illustrates a circuit board layer of an electronics teaching aid, according to an embodiment of the present invention; and

FIG. 6 illustrates an electronics teaching system comprising a plurality of interconnected teaching aids, according to an alternative embodiment of the present invention;

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

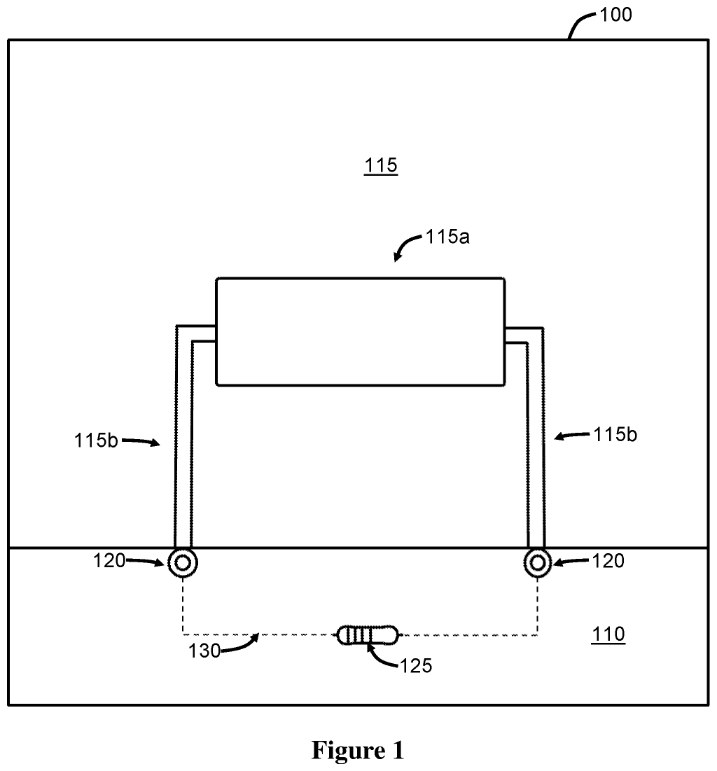

FIG. 1 illustrates a front view of an electronics teaching aid 100, according to an embodiment of the present invention. As described in further detail below, the electronics teaching aid 100 enables a seamless transition between theoretical teachings and practical demonstration in a traditional classroom setting. As a result, the teaching aid 100 may allow students to more easily grasp theoretical concepts and relate these to practical interactions.

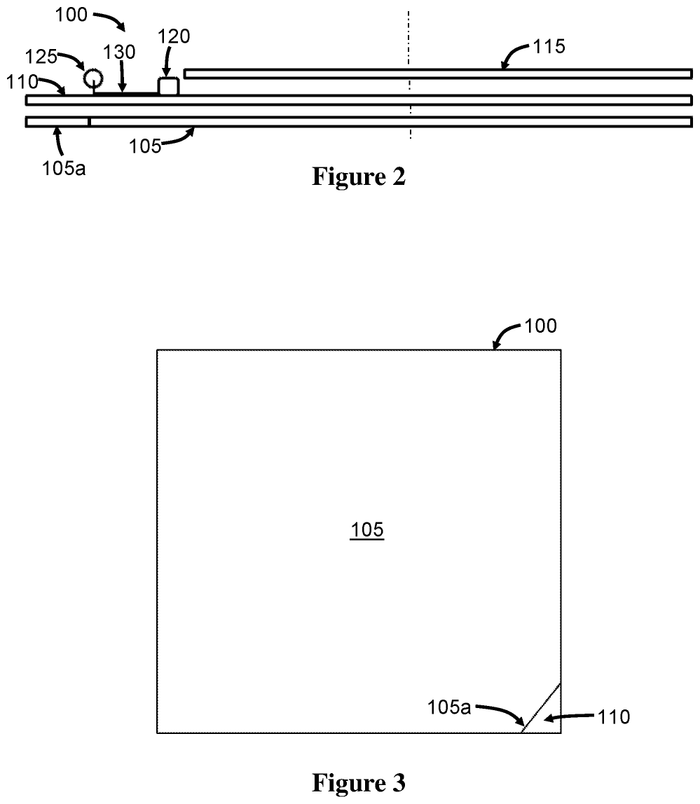

FIG. 2 illustrates an exploded site view of the teaching aid 100, and illustrates a magnetic backing layer 105, a circuit board layer 110, and a schematic layer 115. The magnetic backing layer 105 is located at a rear of the aid 100, and enables the teaching aid 100 to attach to a ferromagnetic surface, such as a magnetic classroom whiteboard.

The circuit board layer 110 comprises a printed circuit board on which a portion of an electrical circuit is provided. In particular, first and second terminals 120 are provided on the circuit board layer, between which the portion of the electrical circuit extends.

In the example of FIG. 1, the portion of the electrical circuit comprises a resistor 125 coupled between the first and second terminals 120 by conductive tracks 130. The conductive tracks 130 comprise copper laminated onto a non-conductive substrate of the circuit board layer 110, as is well understood in the art of printed circuit boards.

The terminals 120 enable the teaching aid 100 to be dynamically connected to other aids 100, to a power source, and to other electrical components, to generate complete circuits. As outlined in further detail below, a plurality of teaching aids 100 are advantageously coupled to each other during a class to illustrate electrical concepts to the students.

The schematic layer 115 is placed above the circuit board layer 110 and graphically provides a schematic of the portion of the electrical circuit of the circuit board layer 110. The schematic is printed in contrasting colour (e.g. black on white) and is large so that it can be seen from a distance, e.g. from a back of a classroom.

The schematic layer 115 includes a resistor element 115a, and first and second wire elements 115b. The first and second wire elements 115b extend from the terminals 120, and as such, the schematic layer 115 and the circuit board layer 110 are aligned at the terminals. As such, when a circuit is generated with the teaching aid 100, e.g. by coupling a plurality of teaching aids 100 together, a schematic is generated (from the schematic layer(s) 115 and physical wires), as well as an electrical circuit (from the circuit board layer 110 and the physical wires).

As such, visual representation of the circuit (i.e. the schematic) is inextricably linked to the actual circuit. This allows the teacher to demonstrate a circuit physically (practically) and theoretically in the same time and space and through a single action.

The magnetic backing layer 105 enables the system 100 to be coupled vertically, e.g. on a whiteboard. As such, circuits can be generated in a manner which enables them to be easily seen by a plurality of students, and in a classroom setting. Also, by using the aids 100 in a traditional theoretical setting (i.e. a classroom), practical observations may be made by students within this environment, which can enhance retention of information.

As best illustrated in FIG. 3, the magnetic backing layer 105 fills an entire back surface of the circuit board layer 110, with the exception of a tab portion 105a, which enables the teaching aid 100 to be easily removed from a surface. In particular, the exposed corner piece provided by the tab portion 105a enables the user to get their finger/fingernail behind the circuit board layer 110 and pull the teaching aid 100 directly from the surface.

In an alternative embodiment, the circuit board layer 110 includes a peg, or handle, which is configured to enable the user to pull the teaching aid 100 directly from the surface. Advantageously, the peg or handle is located at a corner (e.g. the bottom right corner) which is both functional (it is easier to remove the teaching aid 100 from a corner), and aesthetically pleasing (it does no shield the schematic layer 115).

The schematic layer 115 advantageously covers more than half of the circuit board layer 110, to provide an efficient view of the schematic to the user. In particular, the wire elements 115b are much thicker than the tracks 130, which enables the wire elements 115b to be seen from a much further distance from the aid 100 than the tracks (which may not be visible unless very close to the aid 100). Similarly, the resistor element 115a is much larger than the resistor 125.

According to certain embodiments (not illustrated), the teaching aid 100 includes a Quick Response (QR) code that provides a link to media relating to the circuit. As an illustrative example, the QR code may comprise an encoded Uniform Resource Locator (URL) linking to an online video describing or clarifying the circuit. The QR code may be positioned on the circuit board layer 110, adjacent to the circuit. Such positioning enables easy access to the QR code while in use (e.g. be scanned by a smartphone of a student), while not distracting from the schematic of the schematic layer 115 when viewed from a distance.

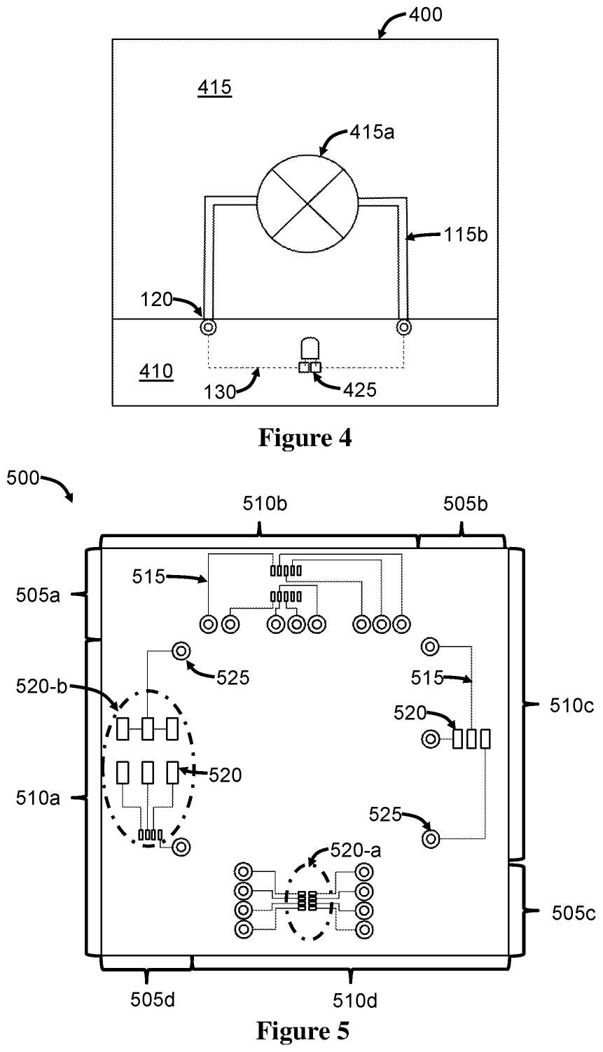

FIG. 4 illustrates a front view of an electronics teaching aid 400, according to an embodiment of the present invention. The electronics teaching aid 400 is similar to the teaching aid 100, but includes a light 425 rather than a resistor 125.

The electronic teaching aid 400 includes a circuit board layer 405, similar to the layer 105, but with the light 425 soldered thereto. Similarly, the electronic teaching aid 400 includes a schematic layer 415, similar to the layer 115, but with a light element 415a between the wire elements 115b (and terminals 120).

The skilled addressee will readily appreciate that the circuit board layers 110, 410 of the teaching aids 100, 400 may be provided without the resistor 125 or light 425, and be configured such that a teacher (or other suitable person) solders a desired component onto the circuit. In such case, the circuit board layers of the teaching aids 100, 400 may be identical initially, and be adapted to incorporate a resistor, light, or other suitable component. A suitable schematic layer 415, 115, may then be added thereto.

Furthermore, circuit board layers may be provided that have a plurality of alternative circuit configurations, as outlined below. Such setup may reduce manufacturing costs, as a single circuit board layer can be produced for multiple different configurations. Furthermore, such setup may provide increased flexibility, as kits may be provided for completion at schools, where the configurations may be selected as needed.

FIG. 5 illustrates a printed circuit board layer 500 of a teaching aid, prior to installation of any electrical components, according to an embodiment of the present invention. The printed circuit board layer 500 is similar to the circuit board layer 110, 410, and is configured to be completed through installation of electrical components onto one or more predefined zones.

The circuit board layer 500 includes four (4) configuration zones 505a-d illustrated on its first side, and may include a further four (4) configuration zones on its second side (not illustrated).

Each of the configuration zones 505a-d is provided on an edge of the circuit board layer 500, which is substantially rectangular in shape. As such, components may be installed into one of the zones 505a-d to generate a circuit board layer 500 for use in a teaching aid, such as the teaching aid 100 or teaching aid 400.

The configuration zones 505 are non-overlapping at their edge, and as such, may be used with a schematic layer of fixed size. In particular, the circuit board layer 500 may be rotated (and turned if double sided) so that a desired configuration zone 505 is provided at a lower end of the circuit board layer 500. Components are then soldered thereto, and a magnetic layer and schematic layer are attached to complete the teaching aid.

In other words, above each configuration zone 505a-d is associated with a corresponding schematic zone 510a-d. Each configuration zone 505a-d and schematic zone 510a-d pair fills the entire circuit board layer 500 such that each schematic zone 510a-d covers all other configuration zones 505a-d.

As a result, each configuration of the circuit board layer 500, when a schematic layer is installed onto a schematic zone 510a-d, results in a teaching aid where all other (alternative) configurations are hidden, thus providing a clean (and easy to understand) teaching aid.

Each configuration zone 505a-d includes a plurality of predefined tracks 515 that define part of the circuit. The tracks 515 extend from pads 520, i.e. portion of metal on the surface of the board to which a component is to be soldered, or from an annular ring 525, i.e. a ring of metal around a plated through hole to which a terminal is to be soldered.

The pads 520 are placed to simplify installation of various “standard” components. For example, the pads 520-a are configured to be used together with an 8-pin dual in-line package (DIP) Integrated circuit (IC) chip, and the pads 520-b are configured to be used together with a three-way switch and three alternative components.

The above described circuit board layer 500 is also particularly useful in that allows teaching aids to be repurposed. As an illustrative example, a teaching aid may be stripped back to the circuit board layer 500, upon which a new configuration is chosen and new components are installed. This is particularly useful as a school's needs change over time.

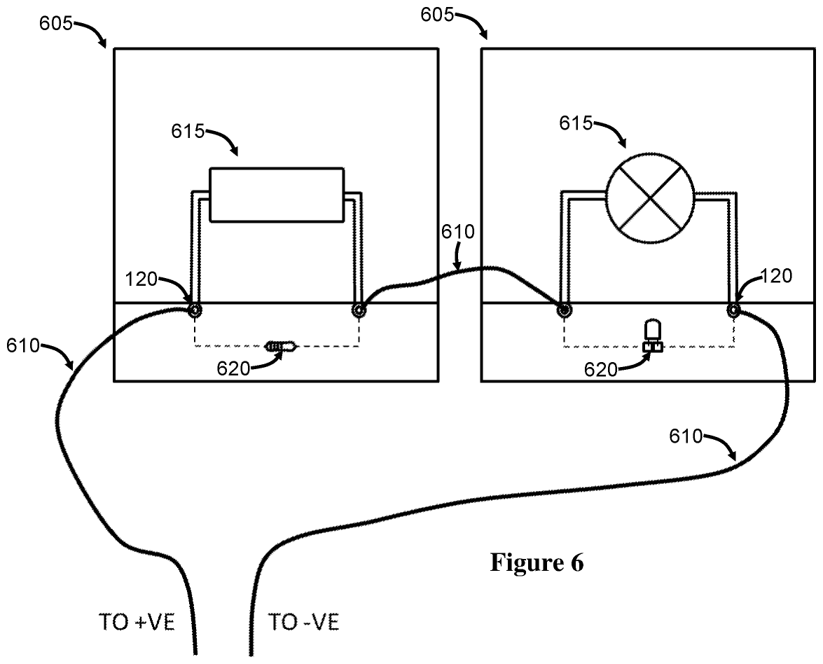

FIG. 6 illustrates an educational system 600 comprising a plurality of educational aids 605, according to an embodiment of the present invention.

The educational aids 605 may be similar or identical to the aid 100 of FIG. 1 or the educational aid 400 of FIG. 4, and are used to illustrate portions of a circuit. In particular, each aid 605 may illustrate a different portion of a circuit (e.g. a resistor, a capacitor, a light, a diode, or a combination thereof), which are together coupled to form a larger circuit.

Electrical wires 610 are used to couple the educational aids 605 through their respective terminals 120. The wires 610 have an outer plastic layer, which both protects the conductive material of the wires 610 and which makes them large and easy to see. As such, when a circuit is generated between the aids 605, a clear schematic of the circuit is illustrated by the wires 610 and schematic portions 615 the aids 605.

Furthermore, the wires 610 and circuit layers of the aids 605 provides an actual circuit from circuit portions 620, corresponding to the schematic, which enables a reach to demonstrate the circuit without interruption. As an illustrative example, once the circuit is completed (i.e. coupled), the teacher may connect a multimeter to different parts of the circuit (e.g. to terminals) to demonstrate theoretical concepts. For example, the teacher may illustrate a voltage drop across the resistor by coupling the multimeter to the first and second terminals of the educational aid 605 comprising a resistor.

Furthermore, the teacher may dynamically reconfigure the circuit by adding and removing educational aids 605, and/or by coupling the educational aids 605 in a different manner.

While the above embodiments have been described with reference to electrical circuits, the skilled addressee will readily appreciate that other types of circuits may be used, including electromechanical circuits, pneumatic circuits, hydraulic circuits, a combination thereof, or any other suitable circuit.

Similarly, while the embodiments have been described in the context of a teacher in a traditional classroom, the skilled addressee will readily appreciate that the teaching aids may be used in other contexts, such as in lecture style environments, in labs, and in any suitable educational context. For example, the teaching aids may be used in a demonstrative manner by a teacher, or in an interactive manner by the student(s).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An educational aid comprising:
a circuit layer comprising a circuit component, including first and second terminals and a portion of a circuit there between;
a schematic layer comprising a schematic of the portion of a circuit extending between the first and second terminals, wherein the schematic layer covers at least part of the circuit layer; and
a magnetic layer, configured to support the educational aid vertically;
wherein the educational aid is configured to be coupled to other educational aids using the terminals, to simultaneously create a circuit and a corresponding schematic.

2. The educational aid of claim 1, wherein the circuit layer, the schematic layer and the magnetic layer comprise planar layers.

3. The educational aid of claim 1, wherein the magnetic layer covers substantially an entire back of the circuit layer.

4. The educational aid of claim 1, wherein the circuit layer includes a plurality of alternative configurations on edges of the circuit layer, of which one or more is chosen to define the circuit component, wherein the alternative configurations may comprise predefined tracks, in relation to which components may be mounted.

5. An educational system comprising:
a plurality of educational aids, each educational aid comprising:
a circuit component, including first and second terminals and a portion of a circuit there between; and
a schematic of the portion of a circuit extending between the first and second terminals; and
a plurality of coupling elements, for coupling the plurality of educational aids with each other by respective first and second terminals;
wherein the educational aids are configured to be coupled with each other using the coupling elements, to simultaneously create a circuit and a corresponding schematic.

6. The educational aid of claim 1, wherein the circuit comprises an electromechanical circuit, a pneumatic circuit, a hydraulic circuit, or a combination thereof.

7. The educational aid of claim 1, wherein the circuit is an electronic circuit.

8. The educational aid of claim 7, wherein the first and second terminals each comprise a connector or fastener, wherein the connector or fastener is specifically adapted to retain a conductive wire.

9. The educational aid of claim 7, wherein the schematic comprises wire elements, and one or more component elements.

10. The educational aid of claim 9, wherein the wire elements extend to the edge of the schematic layer.

11. The educational aid of claim 1, wherein the circuit board layer comprises a printed circuit board on which a portion of an electrical circuit is provided.

12. The educational aid of claim 1, wherein the schematic layer covers more than half of the circuit layer.

13. The educational aid of claim 1, further including a tab portion to simplify removal of the aid from a magnetic surface.

14. The educational aid of claim 1, wherein the schematic is printed on the schematic layer.

15. The educational aid of claim 1, including a Quick Response (QR) code that provides a link to media relating to the circuit.
